(19) United States
(12) Patent Application Publication
(10) Pub. No.: US 2002/0039252 A1
(43) Pub. Date: Apr. 4, 2002

(54) Finned base airstream conditioning apparatus for a data storage device

(76) Inventors: Srinivas Tadepalli, Eden Prairie, MN (US); David Allsup, Oklahoma City, OK (US)

Correspondence Address: Shawn B. Dempster, Seagate Technology LLC, 1280 Disc Drive - SHK2LG, Shakopee, MN, 55379-1863, US

(21) Appl. No.: 09/896,884

(22) Filed: Jun. 29, 2001

Related U.S. Application Data
(60) Provisional application No. 60/233,894, filed on Sep. 20, 2000.

(51) Int. Cl. G11B 17/02

(52) U.S. Cl. 360/97.02

(57) ABSTRACT

An airstream conditioning apparatus for a data storage device comprising a motor spinning a data storage disc and a read/write assembly reading data from and writing data to the storage disc. A base supports the motor and the read/write assembly, and defines an arcuate upstanding shroud in a closely fitting relationship transverse to the disc edge. A fin extends from the shroud in planar alignment with the disc edge.

### CROSS REFERENCE TO RELATED APPLICATIONS

This application claims the benefit of U.S. Provisional Application No. 60/233,894 filed Sep. 20, 2000.

### FIELD OF THE INVENTION

This invention relates generally to the field of data storage devices, and more particularly but not by way of limitation to controlling the aerodynamic excitation imparted to device components by air currents generated by the spinning discs in the data storage device.

### BACKGROUND OF THE INVENTION

Modem data storage devices such as disc drives are commonly used in a multitude of computer environments to store large amounts of data in a form that is readily available to a user. Generally, a disc drive has a magnetic disc, or two or more stacked magnetic discs, that are rotated by a motor at high speeds. Each disc has a data storage surface divided into a series of generally concentric data tracks where data is stored in the form of magnetic flux transitions.

A data transfer member such as a magnetic transducer is moved by an actuator to selected positions adjacent the data storage surface to sense the magnetic flux transitions in reading data from the disc, and to transmit electrical signals to induce the magnetic flux transitions in writing data to the disc. The active elements of the data transfer member are supported by suspension structures extending from the actuator. The active elements are maintained a small distance above the data storage surface upon an air bearing generated by air currents generated by the spinning discs.

A continuing trend in the industry is toward ever-increasing data storage capacity and processing speed while maintaining or reducing the physical size of the disc drive. Consequently, the data transfer member and supporting structures are continually being miniaturized, and data storage densities and disc rotation speeds are continually being increased. The result is an overall increased sensitivity to vibration, as a percentage of track width. These vibrations can have an adverse effect on the positioning control systems moving the actuator relative to the spinning discs.

One source of excitation that can no longer be disregarded comes from the air currents moving within the disc stack and impinging on disc drive components. The air current velocity, and hence the associated forces, increase in relation to the radial distance from the axis of rotation. Thus, the air currents move faster and are more likely turbulent at outer portions of the discs. Turbulence can impart adverse vibrations, or aerodynamic excitation, to the discs (flutter) and/or to the actuator, particularly to the suspension members (buffeting). Turbulence can also be created by shedding vortices formed from the actuator wake as the airstream flows past the actuator, and also acting on the disc edges as the air currents are expelled from the disc stack. Further, wake excitation from the actuator increases disc vibration.

It has been determined that airstream excitation can be reduced by an airstream conditioning apparatus comprising a finned shroud disposed substantially fully around the rotating discs. It is to this improvement that embodiments of the present invention are directed.

### SUMMARY OF THE INVENTION

Embodiments of the present invention are directed to an airstream conditioning apparatus for a data storage device. The data storage device has a motor spinning a data storage disc and a read/write assembly reading data from and writing data to the storage disc. The airstream conditioning apparatus comprises a base supporting the motor and the read/write assembly, and defines an arcuate upstanding shroud in a closely fitting relationship transverse to the disc edge. The airstream conditioning apparatus further comprises a fin extending from the shroud in planar alignment with the disc edge.

These and various other features as well as advantages which characterize the present invention will be apparent upon reading of the following detailed description and review of the associated drawings.

### BRIEF DESCRIPTION OF THE DRAWINGS

FIG. 1 is a plan view of a disc drive assembly constructed in accordance with an embodiment of the present invention.

FIG. 2 is a cross-sectional view of a portion of the disc drive taken along the section line 2-2 in FIG. 1.

FIG. 3 is an enlarged portion of the cross-sectional view of FIG. 2 diagrammatically illustrating the diverting of air currents exiting the disc stack.

FIG. 4 is a cross-sectional view similar to FIG. 2 but of a disc drive constructed in accordance with the state of the prior art.

FIG. 5 is an enlarged portion of the cross-sectional view of FIG. 4 illustrating how air currents in adjacent spaces couple to impart aerodynamic excitation on the disc edge.

### DETAILED DESCRIPTION

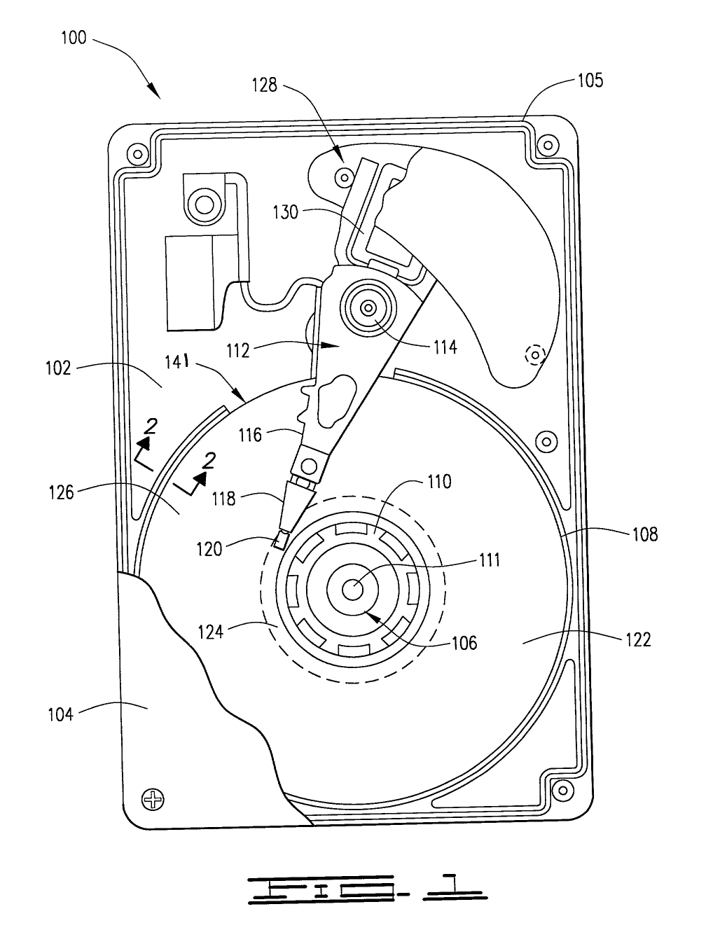

Referring to the drawings in general, and more particularly to FIG. 1, shown therein is a plan representation of a disc drive 100 constructed in accordance with an embodiment of the present invention. The disc drive 100 includes a base 102 to which various disc drive components are mounted, and a cover 104 (partially cut-away) which together with the base 102 and a perimeter gasket 105 form an enclosure providing a sealed internal environment for the disc drive 100. Numerous details of construction are not included in the following description because they are well known to a skilled artisan and are unnecessary for an understanding of the present invention.

Mounted to the base 102 is a motor 106 to which one or more discs 108 are stacked and secured by a clamp ring 110 for rotation at a high speed. Where a plurality of discs 108 are stacked to form a disc stack, adjacent discs 108 are typically separated by a disc spacer (not shown). An actuator 112 pivots around a pivot bearing 114 in a plane parallel to the discs 108. The actuator 112 has actuator arms 116 (only one shown in FIG. 1) that support load arms 118 in travel across the discs 108 as the actuator arms 116 move within the spaces between adjacent discs 108. The load arms 118 are flex members that support data transfer members, such as read/write heads 120, with each of the read/write heads 120 adjacent a surface of one of the discs 108 and maintained in a data reading and writing spatial relationship by a slider (not shown) which operably supports the read/write head 120 on an air bearing sustained by air currents generated by the spinning discs 108.

Each of the discs 108 has a data storage region comprising a data recording surface 122 divided into concentric circular data tracks (not shown). Each of the read/write heads 120 is positioned adjacent a respective desired data track to read data from or write data to the data track. The data recording surface 122 can be bounded inwardly by a circular landing zone 124 where the read/write heads 120 can come to rest against the respective discs 108 at times when the discs 108 are not spinning. Alternatively, the landing zone can be located elsewhere on the disc 108, if at all.

The actuator 112 is positioned by a voice coil motor (VCM) 128 comprising an electrical coil 130 and a magnetic circuit source. The magnetic circuit source conventionally comprises one or more magnets supported by magnetic poles to complete the magnetic circuit. When controlled current is passed through the actuator coil 130, an electromagnetic field is set up which interacts with the magnetic circuit causing the actuator coil 130 to move. As the actuator coil 130 moves, the actuator 112 pivots around the pivot bearing 114, causing the read/write heads 120 to travel across the discs 108.

As noted earlier, the motor 106 spins the discs 108 at high speeds as the read/write head 120 reads data from and writes data to the data storage surface 122. Kinetic energy transfers from the spinning discs 108 transfers to the air within the disc stack, imparting air currents moving within the disc stack. The rotating disc imparts a rotational force component to the air currents, and centrifugal force imparts a radial force component to the air currents. The resulting air currents form an airstream that generally spirals outwardly from the inner portion of the disc stack, ever-gaining velocity in relation to the faster linear speeds of the discs 108 as the radial distance from the axis of rotation increases.

As data storage densities and processing speed continually increases, the positioning of the actuator adjacent a particular data track becomes more problematic. There are previously disregarded external forces, or “parasitic forces,” that adversely effect both the stability of the spinning discs and of the actuator, creating non-repeatable runnout related errors (NRRO). One such example of parasitic forces come from turbulent air currents in the disc stack.

Turbulent air currents can be created in different ways. For example, the air currents spiraling outwardly within the disc stack can become turbulent after impinging on the actuator assembly. Compensating for this impinging engagement can be complicated by the acceleration of the actuator assembly toward the air currents during track seek operations. Turbulence at the disc edge imparts axial forces creating disc flutter and actuator buffeting, both of which can adversely affect the transfer of data between the read/write head 120 and the data track, creating read and write errors.

Turbulent air currents are generally categorized as being those that impart sufficient shear stresses to create characteristic NRRO effects, like flutter and buffeting.

The disc drive 100 of FIG. 1 has an airstream conditioning apparatus that effectively reduces aerodynamic excitation by shrouding the disc stack. Shrouding laminarizes the flow and reduces three dimensional effects in the enclosure. Shrouding also minimizes the effects of shedding vortices at the disc edges that otherwise produces axial forces on the discs 108. Shrouding also reduces the resistive drag on the spinning discs 108, thereby minimizing the power necessary to maintain the disc stack at a desired rotational speed.

The base 102 defines an upstanding shroud 140 receivingly engaging the spinning disc 108 in a closely fitting relationship. Preferably, the shroud 140 extends along the disc periphery to the greatest extent possible. In FIG. 1, for example, only an opening 141 in the shroud is provided for the actuator 112 to pass through in moving between the inner and outer limits of travel across the disc 108. In this arrangement, the actuator 112 and disc stack would be merged and then assembled together onto the base 102. If merging is required after placement onto the base 102, then the opening 141 would necessarily be larger to permit the distal end of the actuator 112 to pass therethrough.

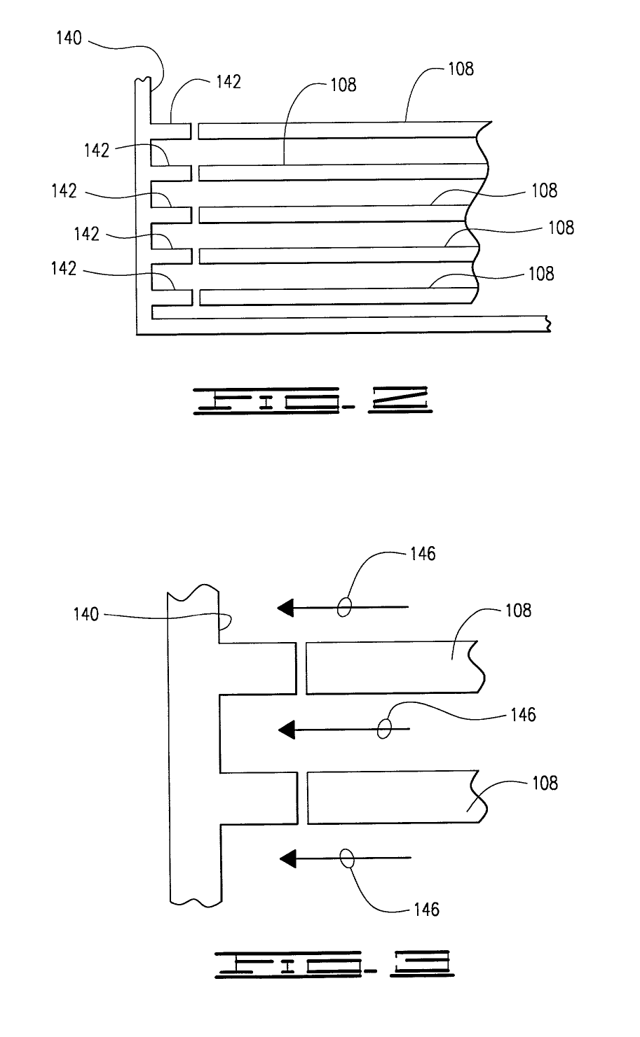

FIG. 2 is a cross-sectional view taken along the line 2-2 of FIG. 1 illustrating, for example, a disc stack comprising five discs 108. This embodiment is illustrative and not limiting to the number of discs in the disc stack, which generally range from one or more within the contemplated embodiments of the present invention. The shroud 140 is disposed substantially transverse to the disc 108 edge. A fin 142 extends from the shroud 140 at one end thereof, terminating at a distal end in an arcuate member around the disc 108 edge.

Each fin 142 is disposed in planar alignment with the associated disc 108, and has a thickness that substantially matches the disc 108 thickness so that the fin 142 and disc 108 together define substantially coextensive surfaces, separated by the small gap therebetween. FIG. 3 is an enlarged detail view of a portion of the cross-sectional view of FIG. 2, diagrammatically illustrating the manner in which these coextensive surfaces guide the air currents (denoted 146) exiting the disc stack.

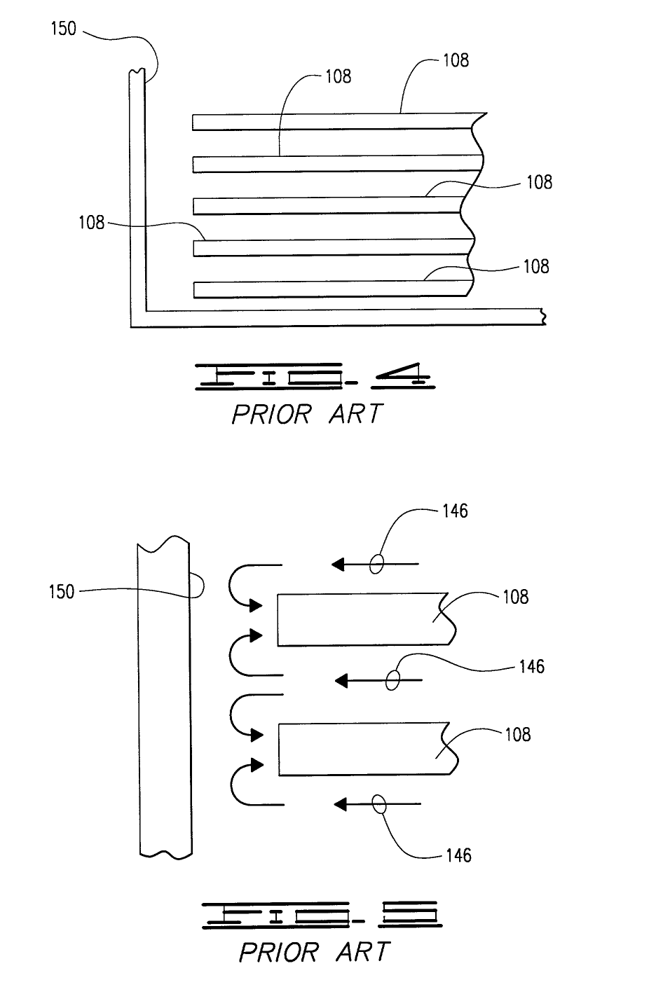

FIGS. 4 and 5 illustrate cross-sectional views similar to FIGS. 2 and 3 for a base shroud assembly constructed in accordance with the state of the prior art. Typically, the shroud 150 is spaced from the disc 108 edge permitting a sufficient exit path for the air currents expelled from the disc stack. FIG. 5, however, illustrates the adverse effects of communication of air currents between adjacent cavities, where coupling currents set up turbulent conditions acting on the disc 108 edge.

The finned shroud provided by the base 102 reduces aerodynamic excitation by providing channeling surfaces that preserve the laminar flow characteristics as the air currents are expelled from the disc stack. Air current coupling between adjacent cavities is substantially eliminated, thereby inhibiting the vertical excitation around the edge of the discs 108 and reducing the disc axial NRRO. Further, as the flow is more laminar due to the base fins, the interaction of the actuator vibration modes with the suspension, as well as flexure assembly vibration modes, are significantly reduced, providing a substantial reduction in the off-track NRRO contribution to position error signal.

In the illustrative embodiments of the preferred embodiment the fins 142 are unitarily formed as a portion of the base 102. Accordingly, the fins 142 can be formed as a portion of a casting to produce the base 102, or the fins 142 can be machined into the base 102. Alternatively, the fins 142 can be an arcuate or flexible component attached to the shroud 140 portion of the base 102.

In summary, an airstream conditioning apparatus is disclosed for a data storage system (such as 100) for attenuating the aerodynamic excitation effects of air currents generated within a data stack of data discs (such as 108) spinning under the control of a motor (such as 106). The data discs spin operatively interfacing with an actuator (such as 112) supporting a read/write assembly (such as 120) in a data reading and writing relationship.

The airstream conditioning apparatus can include a shroud (such as 140) formed by a base (such as 102) of the disc drive, channeling expelled air from the disc stack so as to laminarize the flow and reduce three dimensional effects in the enclosure. The shroud can have a number of fins (such as 142) extending substantially coextensively to the discs and in an edge-to-edge planar relationship to channel the expelled air currents away from the disc stack without coupling of air currents from the spaces between adjacent discs.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the size and placement of the finned base shroud may vary while maintaining substantially the same functionality without departing from the scope and spirit of the present invention. In addition, although the preferred embodiment described herein is directed to a finned base shroud for a disc drive assembly, it will be appreciated by those skilled in the art that the teachings of the present invention can be applied to other systems, like data storage test or certification systems, servo track writers, or optical data storage systems, without departing from the scope and spirit of the present invention.

What is claimed is:

1. An airstream conditioning apparatus for a data storage device, the data storage device having a motor spinning a data storage disc and a read/write assembly reading data from and writing data to the storage disc, the airstream conditioning apparatus comprising:
a base supporting the motor and the read/write assembly, and defining an arcuate upstanding shroud in a closely fitting relationship transverse to the disc edge; and
a fin extending from the shroud in planar alignment with the disc edge.

2. The apparatus of claim 1 wherein the fin and base are unitarily formed.

3. The apparatus of claim 1 wherein the fin and the disc are substantially the same thickness.

4. The apparatus of claim 1 wherein the data storage device has a data storage disc stack including a plurality of data discs and the airstream conditioning apparatus comprises a like plurality of fins associated with the discs.

5. The apparatus of claim 1 wherein the data storage device is a disc drive assembly.

6. A disc drive, comprising:
an enclosure comprising a base and a cover, the base defining an upstanding shroud portion;
a motor supported by the enclosure and rotating a data storage disc in a plane of rotation substantially transverse to the shroud;
an actuator supported by the enclosure in a data transfer relationship with the disc; and
a fin extending from the shroud and terminating in an arcuate member in planar alignment with the disc edge.

7. The disc drive of claim 6 wherein the fin and base are unitarily formed.

8. The disc drive of claim 6 wherein the fin and the disc are substantially the same thickness.

9. The disc drive of claim 6 wherein the data storage device has a data storage disc stack including a plurality of data discs and the airstream conditioning apparatus comprises a like plurality of fins associated with the discs.

10. A data storage device, comprising:
a spinning data storage disc in operable reading and writing data relationship with an actuator assembly; and
means for limiting the aerodynamic excitation resulting from airstreams generated by the spinning disc by closely shroud the spinning disc with a finned annular supporting base.

11. The device of claim 10 wherein the finned annular supporting base comprises a fin disposed in planar alignment with the disc.

12. The device of claim 10 wherein the fin and base are unitarily formed.

13. The device of claim 10 wherein the fin and the disc are substantially the same thickness.

14. The device of claim 10 wherein the data storage device has a data storage disc stack including a plurality of data discs and the airstream conditioning apparatus comprises a like plurality of fins associated with the discs.

15. The device of claim 10 wherein the data storage device is a disc drive assembly.
